(19) United States
(12) Patent Application Publication
(10) Pub. No.: US 2010/0075137 A1
(43) Pub. Date: Mar. 25, 2010

(54) CARBON NANOTUBE SYNTHESIS USING REFRACTORY METAL NANOPARTICLES AND MANUFACTURE OF REFRACTORY METAL NANOPARTICLES

(75) Inventors: Steve Sinton, Palo Alto, CA (US); Justin S. Golightly, Sunnyvale, CA (US); Jyotsna Iyer, Sunnyvale, CA (US); Peter V. Bedworth, Palo Alto, CA (US); Alfred A. Zinn, Palo Alto, CA (US); Charles M. Packer, Emerald Hills, CA (US)

Correspondence Address: MCDERMOTT WILL & EMERY LLP, 18191 VON KARMAN AVE., SUITE 500, IRVINE, CA, 92612-7108, US

(73) Assignee: LOCKHEED MARTIN CORPORATION, Bethesda, MD (US)

(21) Appl. No.: 12/426,160

(22) Filed: Apr. 17, 2009

Related U.S. Application Data
(63) Continuation-in-part of application No. 11/798,529, filed on May 15, 2007.
(60) Provisional application No. 61/046,766, filed on Apr. 21, 2008.
(60) Provisional application No. 60/800,855, filed on May 17, 2006.

(51) Int. Cl. B32B 5/16; B22F 9/16; B05D 1/36; B22F 1/00

(52) U.S. Cl. 428/328; 75/370; 427/201; 75/252; 977/742; 977/895; 977/890

(57) ABSTRACT

Fabrication of refractory metal nanoparticles and carbon nanotubes is disclosed. As an example, a method may include providing a solvent and providing a surfactant having a first surfactant configured to stabilize low oxidation states of a refractory metal and a second surfactant configured to protect refractory metal nanoparticles. The method may further include providing a refractory metal precursor and providing a reactant for reacting with the refractory metal precursor and forming refractory metal nanoparticles. The refractory metal may include rhenium, tungsten, tantalum, or hafnium. The refractory metal nanoparticles may include rhenium, tungsten, tantalum, or hafnium nanoparticles. A carbon nanotube product may include refractory metal nanoparticles and carbon nanotubes, where the refractory metal nanoparticles may include rhenium, tungsten, tantalum, or hafnium nanoparticles.

### CROSS-REFERENCES TO RELATED APPLICATIONS

The present application is a continuation-in-part of U.S. patent application Ser. No. 11/798,529 entitled “RHENIUM NANOPARTICLES” filed on May 15, 2007, which claims the benefit of U.S. Provisional Patent Application Ser. No. 60/800,855 entitled “FORMATION OF NANOSTRUCTURED RHENIUM (RE) COATINGS,” filed on May 17, 2006, and the present application claims the benefit of U.S. Provisional Patent Application Ser. No. 61/046,766, entitled “SINGLE WALLED CARBON NANOTUBE SYNTHESIS USING REFRACTORY METAL NANOPARTICLES,” filed on Apr. 21, 2008. All of the foregoing applications are hereby incorporated by reference in their entirety for all purposes.

### STATEMENT AS TO RIGHTS TO INVENTIONS MADE UNDER FEDERALLY SPONSORED RESEARCH OR DEVELOPMENT

Not Applicable.

### BACKGROUND

Carbon nanotubes may include single-walled carbon nanotubes (SWCNTs) and multi-walled carbon nanotubes (MWCNTs). Carbon nanotubes may be used in various applications such as electronics devices, high strength materials, electron field emission, tips for scanning probe microscopy, and gas storage. In some applications, it may be advantageous to use single-walled carbon nanotubes over multi-walled carbon nanotubes. While carbon nanotubes have been produced, these nanotubes included mixtures of nanotube types along with unwanted byproducts and contaminants.

### SUMMARY

In one aspect of the disclosure, a method for manufacturing refractory metal nanoparticles comprises providing a solvent and providing a surfactant comprising a first surfactant configured to stabilize low oxidation states of a refractory metal and a second surfactant configured to protect refractory metal nanoparticles. The method further comprises providing a refractory metal precursor, the refractory metal precursor comprising the refractory metal and one or more additional elements. The method also comprises providing a reactant for reacting with the refractory metal precursor and forming the refractory metal nanoparticles surrounded by the second surfactant. The refractory metal comprises rhenium, tungsten, tantalum, or hafnium. If the refractory metal comprises rhenium, the refractory metal nanoparticles comprise rhenium nanoparticles. If the refractory metal comprises hafnium, the refractory metal nanoparticles comprise hafnium nanoparticles. If the refractory metal comprises tantalum, the refractory metal nanoparticles comprise tantalum nanoparticles, and if the refractory metal comprises tungsten, the refractory metal nanoparticles comprise tungsten nanoparticles.

In another aspect of the disclosure, a carbon nanotube product comprises a plurality of refractory metal nanoparticles and a plurality of carbon nanotubes on the plurality of refractory metal nanoparticles. The plurality of refractory metal nanoparticles comprises a plurality of rhenium nanoparticles, a plurality of tungsten nanoparticles, a plurality of tantalum nanoparticles, or a plurality of hafnium nanoparticles. If the plurality of refractory metal nanoparticles comprises a plurality of rhenium nanoparticles, then the plurality of refractory metal nanoparticles has an average diameter greater than 0 nanometer and less than 999 nanometers, and the plurality of refractory metal nanoparticles are monodispersed.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

FIG. 1 is a flowchart illustrating a method for manufacturing nanoparticles in accordance with one aspect of the disclosure.

FIG. 2 is a flowchart illustrating a method for manufacturing rhenium nanoparticles in accordance with one aspect of the disclosure.

FIG. 3 illustrates a reactor used in the manufacture of nanoparticles in accordance with one aspect of the disclosure.

FIG. 4 illustrates a rhenium nanoparticle surrounded with surfactant molecules in accordance with one aspect of the disclosure.

FIG. 5 illustrates a rhenium nanoparticle mixture in accordance with one aspect of the disclosure.

FIG. 6 is a flowchart illustrating a method for placing nanoparticles on a substrate in accordance with one aspect of the disclosure.

FIG. 7 is a schematic block diagram illustrating an example of a chemical vapor deposition (CVD) reactor that can be employed to grow nanotubes according to one aspect of the disclosure.

FIG. 8 is an example of a diagram illustrating a substrate with nanoparticles according to one aspect of the disclosure.

FIG. 9 is another example of a diagram illustrating a substrate with nanoparticles according to one aspect of the disclosure.

FIG. 10 is an example of a diagram illustrating carbon nanotubes grown on nanoparticles according to one aspect of the disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. In some instances, well-known structures and components are shown in block diagram form in order to avoid obscuring the concepts of the subject technology Like components are labeled with identical element numbers for ease of understanding.

According to one aspect of the disclosure, the production of single-walled carbon nanotubes (SWCNTs) with specific diameter and chiral character is needed to extract the full value of these materials in electronic and structural applications. So far, all efficient methods for the production of single-wall carbon nanotube create mixtures of nanotube types along with unwanted byproducts and contaminants. These methods utilize nano-sized metal particles to catalyze the decomposition of a source gas (such as methane or acetylene) and growth of nanotubes in a high temperature environment. According to one approach, metal catalysts used are iron (Fe), cobalt (Co), nickel (Ni) and other transition metals. SWCNTs are formed from these nanometal particles when chemical vapor deposition (CVD) conditions (temperature, pressure, gas flow rate, gas composition) are appropriate. If the reaction temperature is too low, predominantly multi-walled nanotubes may be formed. If the temperature it too high, the metals may form carbides and become “poisoned” from further nanotube production. At the temperatures used for chemical vapor deposition (CVD) synthesis of SWCNT, the surface atoms of these metal nanoparticles may be in a liquid-like state. In this condition, carbon ring nucleation and initial formation of the nanotube structure is a mostly random process. So far, these limitations have prevented the successful synthesis of single nanotube types by CVD methods.

In one aspect of the disclosure, the subject technology generally relates to nanotubes or nanoparticles. In one aspect, it may be advantageous to use SWCNTs, and in another aspect, the nanotubes may be multi-walled carbon nanotubes (MWCNTs). In one aspect, a nanoparticle may be a refractory metal nanoparticle (e.g., rhenium (Re), tungsten (W), tantalum (Ta), and/or hafnium (Hf) nanoparticles). In another aspect, nanoparticles may include one or more of these refractory metal nanoparticles in conjunction with another metal. In one aspect, the subject technology may relate to methods and systems for manufacturing refractory metal nanoparticles, and respective refractory metal nanoparticle mixtures, for highly controlled growth of SWCNTs. In another aspect, the subject technology may relate to advanced sensors, materials & structures, or photonics & optical computing. In yet another aspect, the subject technology may relate to carbon, nanotube, selective, synthetic, nanotechnology, synthesis, electronic, optical, catalyst, refractory, rhenium, molybdenum, cobalt, nickel, iron, hafnium, or tantalum devices and/or processes.

According to one aspect of the disclosure, SWCNTs are manufactured using nanoparticles of so-called refractory metals, e.g., metals with higher melting temperatures and less tendency to form carbides than the more typically used CVD catalyst metals. In one aspect, these refractory metals may include rhenium, tungsten, tantalum, and hafnium for SWCNT catalysis. An advantage of rhenium is that besides having a very high melting temperature, rhenium does not readily form carbides. By using high-melting, carbide resistant metals such as rhenium, a more controlled catalytic process can be achieved in CVD SWCNT synthesis. At lower CVD temperatures, rhenium nanoparticles can maintain more order in their surface atoms, providing more control of the geometric fit between growing nanotube and metal surface atoms. Alternately, using rhenium for the catalyst at much higher CVD temperatures can avoid catalyst poisoning and extend the range of possible growth conditions. Rhenium nanoparticles can also be used in conjunction with another metal in a core-shell arrangement: a rhenium core particle can provide shape stability at high temperature, thus a stable surface for and outer shell of another, more catalyticly active metal.

According to one aspect of the disclosure, carbon nanotubes are formed from nano-sized particles of rhenium and/or other refractory metals. In one aspect, a process of the subject technology can produce carbon nanotubes of one type (i.e., the desired type) without the undesired types of carbon nanotubes. For example, in one aspect, a process of the subject technology can produce single-walled carbon nanotubes only without double-walled or multi-walled carbon nanotubes. In another aspect, a process of the subject technology can produce double-walled carbon nanotubes only or multi-walled nanotubes only, as desired.

It should be noted that in one aspect, forming a catalyst (e.g., rhenium on magnesium oxide) as a foam may be disadvantageous, and the formation of nanotubes therefrom may not be well controlled or characterized. In another aspect, while bimetal catalyst systems based on combinations of rhenium with other metals, such as cobalt, may be used to form SWCNTs, such systems may not be well controlled.

According to one aspect of the disclosure, formation of nanoparticles of a refractory metal through chemical pathways can yield distinct, well characterized nano-sized metal particles. In one aspect, the subject technology marries a method for producing the required nanoparticles with a method for using refractory metal nanoparticles as catalysts for CVD production of carbon nanotubes such as SWCNTs. In one aspect, a chemical approach of producing nanoparticles (such as rhenium nanoparticles) can provide unprecedented control of the nanoparticle size and shape, enabling more control and specificity in CVD processes for carbon nanotubes such as SWCNTs. In one aspect, rhenium is used as a catalyst for nanotubes.

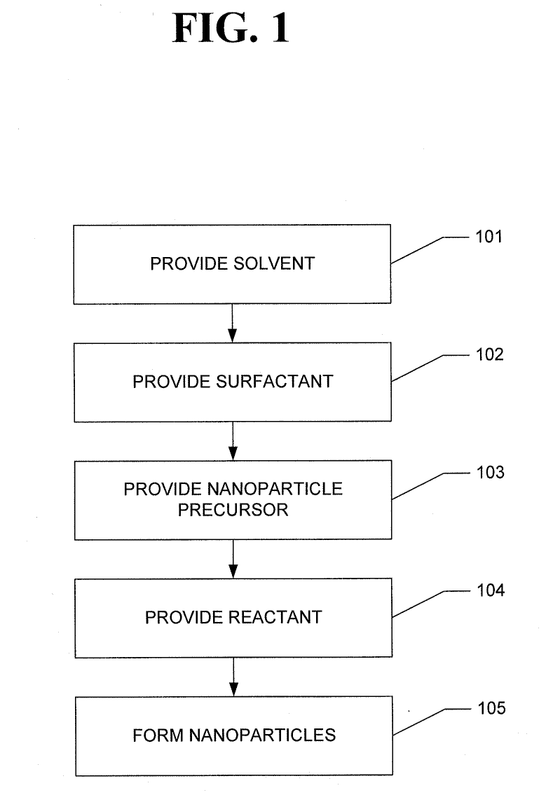

FIG. 1 is a flowchart illustrating a method for manufacturing nanoparticles in accordance with one aspect of the subject technology. In step 101, a solvent is provided. For example, a solvent such as a glyme solvent is provided. In accordance with various aspects of the subject technology, the solvent may be monoglyme CH₃—O—CH₂CH₂—O—CH₃, diglyme CH₃—O—(CH₂CH₂—O)₂—CH₃, triglyme CH₃—O—(CH₂CH₂—O)₃—CH₃, or any other glyme characterized by the chemical formula CH₃—O—(CH₂CH₂—O)ₓ—CH₃, where x is a positive integer.

In step 102, a surfactant is provided. For example, a surfactant is provided into the solvent of step 102. The term “a surfactant” may refer to one or more surfactants. A surfactant may be an organic amine, phosphine, and/or a sulfur containing compound. For example, in one aspect, a surfactant may be n-hexylamine (CH₃(CH₂)₅NH₂), n-nonylamine (CH₃(CH₂)₈NH₂), n-dodecylamine (CH₃(CH₂)₁₁NH₂), or any other amine characterized by the chemical formula CH₃(CH₂)ₓNH₂ or (CH₃(CH₂)ₓ)₂NH, where x is a positive integer, pyridine, diethylenetriamine, phosphine (e.g., PR₃ where P=phosphorus, and R=butyl, pentyl, hexyl, heptyl, octyl, nonyl, decyl, phenyl, or benzyl), or a sulfur containing compound (e.g., RSH where R═C4 to C16, S=sulfur, H=hydrogen; and/or RSR (or SR₂) where R is C4 to C16). In one aspect, a surfactant may include (i) an amine as well as (ii) at least one of phosphine or a sulfur containing compound. In another aspect, a surfactant may include (i) an amine as well as (ii) a phosphine and a sulfur containing compound. Having (i) an amine as well as (ii) at least one (or both) of phosphine and a sulfur containing compound may help produce small, uniform nanoparticles (i.e., nanoparticles that are small in size and that are small in size distribution or size variation).

In step 103, a nanoparticle precursor is provided. For example, a rhenium precursor including rhenium and one or more additional elements is provided into the combination of the solvent and the surfactant of steps 101 and 102. In accordance with one aspect of the subject technology, the rhenium precursor may be sodium perrhenate (VII) (NaReO₄).

In step 104, a reactant is provided. For example, a reactant capable of reducing the rhenium in the rhenium precursor to its atomic form is provided into the combination of the solvent, the surfactant, and the rhenium precursor of steps 101, 102 and 103. In one aspect, the reactant may be sodium borohydride (NaBH₄). In another aspect, the reactant may be ascorbic acid. In yet another aspect, the reactant may be an alkaline metal solvated using naphthalene. The alkaline metal can be sodium (Na), lithium (Li) or potassium (K). The Alkaline metal is dissolved in tetrahydrofuran (THF), monoglyme or ethylenediamine using naphthalene as a promoter.

In step 105, nanoparticles are formed. For example, the combination of the rhenium precursor, the reactant and the surfactant in the solvent initiates a chemical reaction which forms rhenium nanoparticles, each of which is surrounded by a layer of molecules of the surfactant. For example, in one aspect, when the rhenium precursor is sodium perrhenate (VII) (NaReO₄), the reactant is sodium borohydride (NaBH₄), and the surfactant includes (i) n-hexylamine (CH₃(CH₂)₅NH₂) and (ii) hexadecanethiol or trioctylphosphine, the reaction proceeds as follows. Initially, the reactant and the rhenium precursor react to free elemental rhenium from the precursor, as illustrated in Equation 1, below:

NaReO₄+7 NaBH₄→nano Re+3.5H₂+3.5B₂H₆+4 Na₂O (1)

The sodium oxide (Na₂O) precipitates out of the solution, and the hydrogen (H₂) and diborane (B₂H₆) gases are boiled off, while the free atoms of Re metal rapidly coalesce to form rhenium nanoparticles. The free electrons in the NH₂ end of the n-hexylamine (CH₃(CH₂)₅NH₂), hexadecanethiol and trioctylphosphine surfactant molecules in the solvent are drawn to and form bonds with the dangling bonds (i.e., the unsaturated bonding orbitals) of the outermost rhenium atoms in the rapidly growing rhenium nanoparticles, such that the surfactant molecules form a protective barrier around the nanoparticles which prevents their further growth. In this fashion, the reaction is halted before the rhenium nanoparticles have had a chance to further coalesce into a larger mass. The amine surfactant stabilizes lower oxidation states of the rhenium (being a hard base it coordinates well to a hard acid (Lewis-Pearson concept)). Once rhenium is in the zero oxidation state, it is considered soft and the sulfur and phosphine surfactants bond preferably to the rhenium.

According to one aspect of the subject technology, the order in which the reagents are combined is important for ensuring a narrow size distribution (or a narrow size variation) of rhenium nanoparticles. For example, when both the surfactant and the rhenium precursor are added to the solvent (and thoroughly distributed therein) before the reactant is added thereto, local differences in the concentration of the rhenium precursor and the surfactant can be avoided. This equilibrium ensures that when the reactant is added, the rhenium nanoparticles that form will form in a similar manner and achieve similar sizes.

Moreover, the speed with which the reactant is added to the reaction is important for ensuring a narrow size distribution of rhenium nanoparticles, in accordance with one aspect of the subject technology. By slowly adding the reactant (e.g., at a rate of less than 60 drops per minute or about 30 to 40 drops per minute), local differences in the concentration of the reactant can similarly be avoided, to ensure that the rhenium nanoparticles form in near-equilibrium conditions and achieve similar final sizes. Alternatively, by more quickly adding the reactant (e.g., at a rate greater than 100 drops per minute), a larger particle size distribution can be achieved (e.g., due to the local concentration differences that occur). In accordance with one aspect of the subject technology, reactant can be slowly added until nearly all of the rhenium precursor has been consumed, at which time a surplus of reactant (i.e., more than is needed to react with all of the rhenium precursor) is quickly added to ensure that all the remaining rhenium precursor is reacted with. This approach can offer the advantage of ensuring that nearly all of the rhenium nanoparticles will achieve a similar size, while also ensuring that all of the rhenium precursor is consumed.

While a surfactant such as n-hexylamine may be used to prevent further rhenium nanoparticle growth, the scope of the subject technology is not limited to this arrangement. Rather, as will be apparent to one of skill in the art, any one of a number of polar surfactant molecules with free electrons or electron pairs may be used as a surfactant with rhenium nanoparticles. Moreover, while one surfactant may be used in one arrangement, the subject technology has application to reactions in which multiple surfactants are used to control the growth of rhenium nanoparticles. For example, the surfactant(s) used may be any one or more surfactants chosen from the illustrative list in Table 1, below:

TABLE 1

| Surfactant Type | Representative List |
|---|---|
| Organic amine (mono | Pyridine |
| RNH₂, di R₂NH, tri R₃N) | Diethylene triamine |
| | Ethylenediamine |
| | Hexyl-, nonyl-, Dodecyl amine (C4 to |
| | C16) |
| Organic thiol | Octanethiol, decanethiol, dodecanethiol |
| | (C4 to C16) |
| Organic thioethers | Diethyl sulfide (C4 to C16) |
| Organic phosphines | Tri-phenyl phosphine, tri-benzyl |
| | phosphine |
| | PR₃ with R = C4 to C16 |

In one aspect, the term “C4 to C16” may refer to “one or more of C4 through C16”. In one aspect, other like terms may be understood in a similar manner.

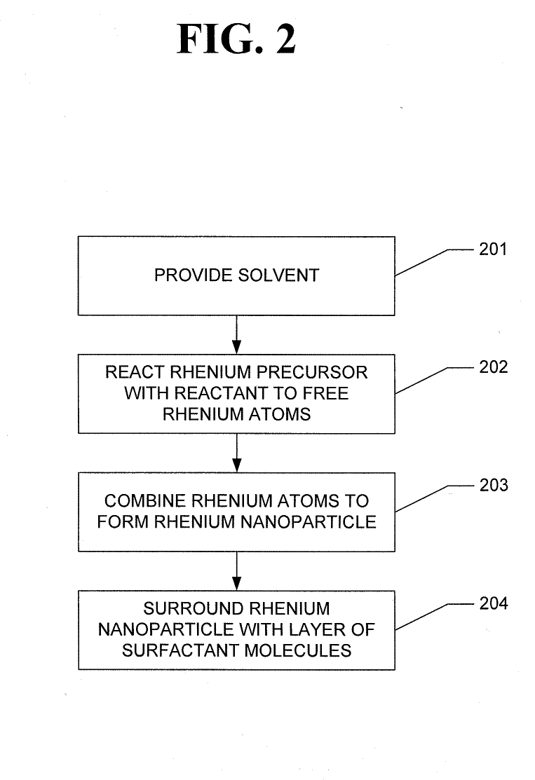

FIG. 2 is a flowchart illustrating a method for manufacturing rhenium nanoparticles in accordance with another aspect of the subject technology. In step 201, a solvent is provided. For example, a glyme solvent, such as monoglyme CH₃—O—CH₂CH₂—O—CH₃, diglyme CH₃—O—(CH₂CH₂—O)₂—CH₃, triglyme CH₃—O—(CH₂CH₂—O)₃—CH₃, or any other glyme characterized by the chemical formula CH₃—O—(CH₂CH₂—O)ₓ—CH₃, where x is a positive integer, is provided. In step 202, a rhenium precursor and a reactant are reacted in the glyme solvent to free rhenium atoms from the precursor. The byproducts of this reaction are precipitated out of solution or boiled off. In step 203, the rhenium particles are combined in the glyme solvent to form a rhenium nanoparticle.

In step 204, the rhenium nanoparticle is surrounded, in the glyme solvent, with a layer of surfactant molecules. The surfactant molecules, which are provided in the solvent at the beginning of the reaction, may be n-hexylamine (CH₃(CH₂)₅NH₂), n-nonylamine (CH₃(CH₂)₈NH₂), n-dodecylamine (CH₃(CH₂)₁₁NH₂), or any other amine characterized by the chemical formula CH₃(CH₂)ₓNH₂, where x is a positive integer and at least one organic phosphine or sulfur containing surfactant such as but not limited to hexadecanethiol and trioctylphosphine. A reactant (or a reducing agent) can be sodium borohydride (NaBH₄) or ascorbic acid.

In one aspect of the disclosure, sodium perrhenate (VII) (NaReO₄) may be dissolved in water with ascorbic acid as the reducing agent in the presence of a plurality of surfactants.

In one aspect of the disclosure, sodium perrhenate (VII) (NaReO₄) may be used as a nanoparticle precursor for metal Re nanoparticle formation. In one aspect, it may be advantageous to use sodium perrhenate rather than ReCl₅ because while ReCl₅ releases chlorine, is moisture and air sensitive, and is difficult to store and handle, sodium perrhenate is stable, easy to handle and can be readily dissolved in many solvents. ReO₄⁻ of sodium perrhenate moves through several oxidation states (+6/+4/+2/0) until reaching its metal state. In one aspect, the use of sodium borohydride allows better size control by keeping the entire solution uniform and in equilibrium.

In accordance with various aspects of the subject technology, three different approaches are described below for producing nanoparticles.

First Approach

The first approach has been described above with respect to FIGS. 1 and 2, and is further described below while referring to FIG. 1. The first approach may utilize the following to produce Re nanoparticles:
A solvent for step 101 may include a glyme solvent.
A surfactant for step 102 may include (i) a monodentate amine as well as (ii) at least one or both of phosphine and a sulfur containing compound.
A nanoparticle precursor for step 103 may include sodium perrhenate (VII) (NaReO₄).

A reactant for step 104 may include (i) ascorbic acid or (ii) sodium borohydride (NaBH₄).

In one aspect, a monodentate amine used as a surfactant may stabilize lower oxidation states of rhenium. In one aspect, phosphine and/or a sulfur containing compound may be utilized for Re nanoparticle stabilization, protection, and monodispersity.

In one aspect, a monodentate amine may be n-hexylamine (CH₃(CH₂)₅NH₂), n-nonylamine (CH₃(CH₂)₈NH₂), n-dodecylamine (CH₃(CH₂)₁₁NH₂), or any other amine characterized by the chemical formula CH₃(CH₂)ₓNH₂ or (CH₃(CH₂)ₓ)₂NH, where x is a positive integer, pyridine, or diethylenetriamine. In one aspect, phosphine may be PR₃ where P=phosphorus, and R=butyl, pentyl, hexyl, heptyl, octyl, nonyl, decyl, phenyl, or benzyl. In one aspect, a sulfur containing compound may be RSH (where R═C4 to C16, S=sulfur, H=hydrogen) and/or RSR (or SR₂) (where R is C4 to C16).

In one aspect, the perrhenate (ReO₄⁻) and the borohydride (BH₄⁻) anion are negatively charged that leads to repulsion slowing down the reduction. Since these two need to meet to transfer electrons and atoms a weak acid like ascorbic acid can produce neutral HReO₄ possibly creating an attractive situation via hydrogen bridging across the oxide atoms in ReO₄⁻. In one aspect, the monodentate amines may stabilize lower oxidation state Re species (Re still hard Lewis acid). In one aspect, the softer sulfur and phosphorus organic ligands (i.e., phosphine and a sulfur containing compound) may stabilize the Re metal nanoparticles.

In one aspect, an operation of this first approach may proceed as follows: (a) provide 30-50 milliliters (ml) of a glyme solvent (step 101); (b) provide a surfactant including 3 ml of diethylenetriamine, 2 ml of n-butyl amine, and 1 ml of SR₂ or RSH, and 1 ml of PR₃ (step 102); (c) dissolve 2.7 g of NaReO₄ in the glyme solvent in the presence of the surfactant described in (b) (step 103); (d) slowly add an solution of ascorbic acid (e.g., 1 drop per sec up to 7 g in 30-50 ml of glyme) (step 104); (e) stir until the solution turns black indicating formation of nanoparticles (step 105). In some examples, some heating may be needed to overcome the repulsive forces. For example, the solution may be heated to 60 to 80° C. until all reactant is added and continue to be heated for 5 to 10 minutes more. In one aspect, the nanoparticles can be extracted from the byproducts by first removing the solvent (e.g., removing the solvent via vacuum or evaporation) and then dissolving the nanoparticles in a nonpolar solvent (e.g., hexane or toluene). In one aspect, the nanoparticles produced are sufficient small so that they can be dissolved in nonpolar solvent such as hexane or toluene due to their hydrophobic surfactant shell. In one aspect, the byproducts are polar and do not dissolve in the nonpolar solvent, and the byproducts may be removed by evaporation.

Second Approach

According to one aspect of the subject technology, a second approach described below may be utilized to produce Re nanoparticles. While referring to FIG. 1, a second approach for producing Re nanoparticles may utilize the following:
A solvent for step 101 may include (i) a glyme solvent, (ii) tetrahydrofuran (THF), or (iii) ethylenediamine (which is sometimes referred to as ED). In one aspect, it may be advantageous to use ethylenediamine rather than THF, and in one aspect, it may be advantageous to use a glyme solvent rather than ethylenediamine
A surfactant for step 102 may include (i) a monodentate amine as well as (ii) at least one or both of phosphine and a sulfur containing compound. This is the same as the first approach described above.
A nanoparticle precursor for step 103 may include sodium perrhenate (VII) (NaReO₄). This is the same as the first approach described above.
A reactant for step 104 may include (i) alkaline-naphthalene (e.g., Na, Li, or K) or (ii) LiAlH₄ as a reducing agent.

In one aspect, a monodentate amine used as a surfactant may stabilize lower oxidation states of rhenium. In one aspect, phosphine and/or a sulfur-containing compound may be utilized for Re nanoparticle stabilization, protection, and monodispersity.

In one aspect, the activated sodium approach can work well with the naphthalene helping to slow down migration and particle growth. In one aspect, LiAlH₄ is a very powerful reducing agent. In one aspect, the monodentate amines can be used to stabilize lower oxidation state Re species (Re still hard Lewis acid). In one aspect, the softer sulfur and phosphorus organic ligands (i.e., phosphine and a sulfur containing compound) may stabilize the Re metal nanoparticles.

In accordance with another aspect of the subject technology, the second approach can be utilized to produce W, Ta or Hf nanoparticles. The technique is the same as the second approach described above for Re nanoparticles, except that (i) instead of using sodium perrhenate (VII) (NaReO₄), a nanoparticle precursor for step 103 may include WCl₆, TaCl₅ or HfCl₄ for W, Ta or Hf nanoparticles, respectively, and (ii) a reactant may be alkaline-naphthalene. In one aspect, it may be advantageous to use any of the following solvents for these metal precursors: glyme, THF, and ED.

A process similar to those described with respect to the first approach may be used to remove the solvent and byproducts.

Third Approach

According to one aspect of the subject technology, a third approach described below may be utilized to produce Re, W, Ta, or Hf nanoparticles. Similar to FIG. 1, in one aspect, an operation of a third approach may proceed as follows: (a) provide a solvent (step 101); (b) provide a surfactant (step 102); (c) provide a nanoparticle precursor (step 103); (d) provide a reactant (step 104); and (e) form nanoparticles (step 105). A third approach for producing Re, W, Ta or Hf nanoparticles may utilize the following:
A solvent for step 101 may include (i) a glyme solvent or (ii) tetrahydrofuran (THF). In one aspect, it may be advantageous to use THF.
A surfactant for step 102 may include (i) a monodentate amine as well as (ii) at least one or both of phosphine and a sulfur containing compound. This is the same as the first approach described above. In one aspect, a monodentate amine used as a surfactant may stabilize lower oxidation states of the metal (e.g., Re, W, Ta or Hf). In one aspect, phosphine and/or a sulfur containing compound may be utilized for metal (e.g., Re, W, Ta, or Hf) nanoparticle stabilization, protection, and monodispersity.
A nanoparticle precursor for step 103 may include ReCl₅, WCl₆, TaCl₅ or HfCl₄ for Re, W, Ta or Hf nanoparticles, respectively.
A reactant for step 104 may include LiR where R is an organic group with a β-hydrogen to allow for ready β-elimination decomposition to occur (e.g., ethyl, propyl, butyl, isopropyl, or isobutyl). In one aspect, the lithium compounds may be the respective LiR compounds such as LiCH₃, and LiC₄H₉.

In one aspect, steps 101 through 104 may be performed at a low temperature (e.g., below 0° C.). When the solvent, surfactant, nanoparticle precursor, and reactant are combined at a low temperature (e.g., below 0° C.), the following reaction may occur:
For Re: ReCl₅+5 LiR→ReR₅+5 LiCl
For W: WCl₆+6 LiR→WR₆+6 LiCl
For Ta: TaCl₅+5 LiR→TaR₅+5 LiCl
For Hf: HfCl₄+4 LiR→HfR₄+4 LiCl

At step 105, the temperature of the solution containing the solvent, surfactant, nanoparticle precursor, and reactant may be raised (e.g., towards room temperature) for decomposition. In one aspect, decomposition may start to occur even below room temperature, and metal nanoparticles may start to form below room temperature. Due to its low stability, the organometallic compound may be produced in situ, and the solution may be further warmed to room temperature or higher to allow decomposition to continue, and to complete the formation of metal nanoparticles. A process similar to those described with respect to the first approach may be used to remove the solvent and byproducts.

This approach utilizes the low thermal stability of organometallic Re, Hf, Ta or W compounds (methyl, ethyl, etc). In one aspect, such compounds are stable at low temperatures and may start to decompose, for example, below 0° C. The compounds can be made using the appropriate Li-organic reagent in the presence of some surfactant, as described above. Subsequently, the temperature is slowly raised leading to the decomposition of the in situ produced organometallic Re, Hf, Ta or W compound.

In one aspect, monodentate amines are used to stabilize the organometallic Re, Hf, Ta or W compounds to some extent (Re, Hf, Ta or W, respectively, still hard Lewis acid). In one aspect, the softer sulfur and phosphorus organic ligands may stabilize the Re, Hf, Ta or W metal nanoparticles.

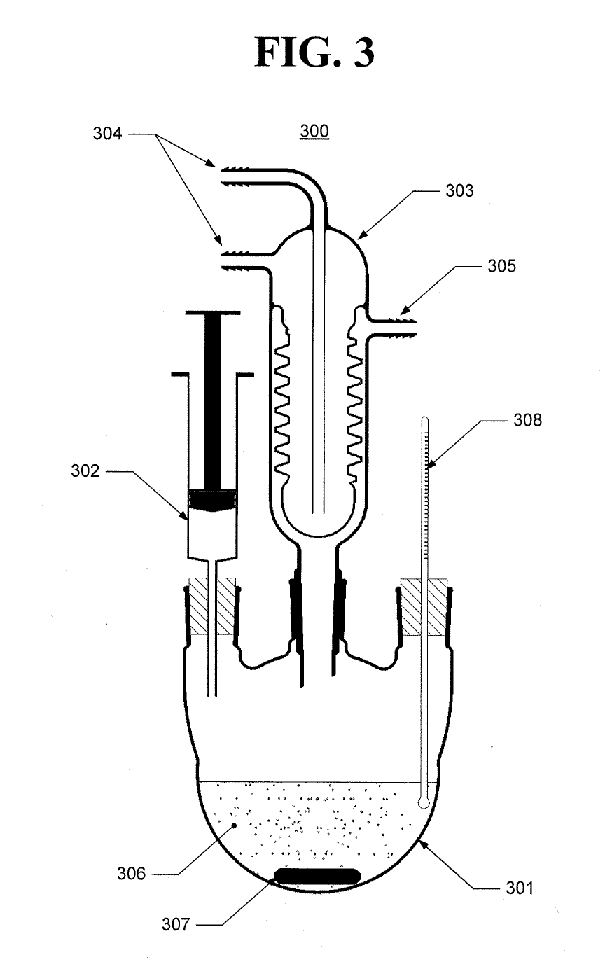

Turning to FIG. 3, a reactor system used in the manufacture of nanoparticles (e.g., metal nanoparticles such as Re, Hf, Ta or W nanoparticles) is illustrated in accordance with one aspect of the subject technology. Reactor system 300 includes a continuous stirred-tank reactor 301, into which reagents 306 are provided via a syringe or an addition funnel 302. An impeller 307 stirs the reagents 306 to ensure thorough mixing thereof (e.g., to optimize the particle size distribution of the metal nanoparticles). A condenser 303 allows gases created in the chemical reactions occurring in reactor 301 (e.g., hydrogen and diborane in one aspect) to escape through outlet 305, while coolant which flows through ports 304 through condenser 303 cools more volatile species (such as the surfactant or the solvent) and allows them to trickle back down along the corkscrew-shaped path in condenser 303 into reactor 301. A thermometer 308 is used to track the temperature of the reagents 306 during the chemical reaction. System 300 may further include a heat source (not illustrated) to increase the temperature of the reaction, and thereby control the size and size distribution of the metal nanoparticles, as described in greater detail below.

According to one aspect of the subject technology, reactor 301 can be heated (or cooled) to control the temperature at which the reactions therein take place. The duration for which heat is applied provides a mechanism for ensuring even distribution of the reagents during the reaction and thorough mixing thereof, so that the size distribution of the metal nanoparticles can be narrowed. For example, in accordance with one aspect of the subject technology, reactor 301 is heated for about 90 minutes after combining the solvent, nanoparticle precursor and surfactant therein to ensure an even distribution thereof.

According to another aspect of the subject technology, the concentration of surfactant in the reaction can similarly modify the resultant size and size distribution of metal nanoparticles. With higher concentrations of surfactant, the metal nanoparticles are more likely to encounter and bond with surfactant molecules early in their growth, resulting in both smaller nanoparticles, and a smaller distribution of particle sizes. In one aspect, the surfactant mixture may have a significant influence over the size and uniformity of the nanoparticles.

While the metal nanoparticles may have been described herein with respect to particular sizes, the scope of the subject technology is not limited to these particular arrangements. For example, by reducing the concentration of surfactant in the reaction or increasing the speed with which the reactant is added thereto, metal nanoparticles larger than 100 nanometers (nm) may be manufactured. Alternatively, by increasing the concentration of surfactant in the reaction, nanoparticles as small as 4 nm or smaller may be manufactured. As will be apparent to one of skill in the art, the subject technology has application to the manufacture of metal nanoparticles of nearly any size.

In accordance with one aspect of a process of the subject technology, 6.0-6.1 grams (g) of NaReO₄ were dissolved in 60 ml of triglyme, to which was added a solution of 3.00-4.00 g of dodecylamine and 2.00-3.00 g of trioctylphosphine and 2 g of 1-Dodecanethiol in 60 ml of triglyme. This entire mixture is stirred at room temperature for 60 minutes to dissolve the perrhenate. Next, 42-45 ml of a NaBH₄/triglyme solution (15 g in 200 ml) was added via an addition funnel at a rate of 30-40 drops per minute. Stirring continued for 20-30 min. To isolate the rhenium nanoparticles, 120 ml of water was added to precipitate the nanoparticles, and the mixture was centrifuged to separate the nanoparticles from the supernatant containing the reaction side-products (e.g., NaOH).

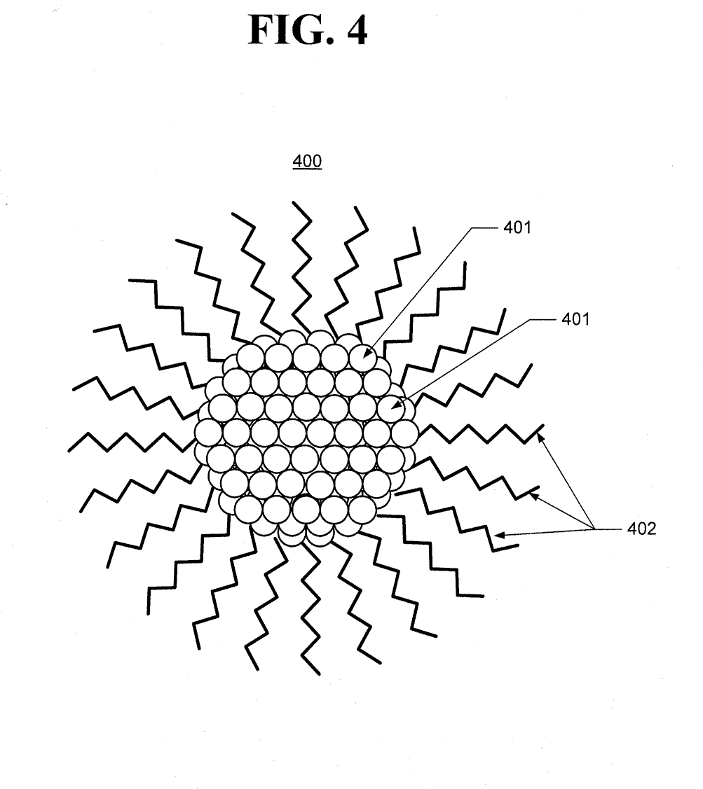

FIG. 4 illustrates a single rhenium nanoparticle in greater detail, in accordance with one aspect of the disclosure. Rhenium nanoparticle 400 includes a plurality of rhenium atoms 401 tightly bonded together. Surrounding rhenium atoms 401 is a layer of surfactant molecules 402, in this case, 1-Dodecanethiol (CH₃(CH₂)₁₁SH). The SH end of each 1-Dodecanethiol molecule has bonded with the dangling bonds (i.e., the unsaturated bonding orbitals) of the outermost rhenium atoms 401 in rhenium nanoparticle 400 to form a protective barrier around nanoparticle 400. While FIG. 4 illustrates a single particle in cross-section, showing only a ring of surfactant molecules at the periphery of the nanoparticle, an actual rhenium nanoparticle has a three-dimensional shell of surfactant molecules 402 surrounding the rhenium atoms 401 on all sides. However, a mixture of thiol and phosphine surfactant is expected when using both for a reaction.

In accordance with one aspect of the subject technology, surfactant molecules 402 need not be the same surfactant molecules used to stop rhenium nanoparticle 400 from growing during the manufacture thereof. Rather, as will be immediately understood by one of skill in the art, a simple ligand exchange may be used to replace some or all of the surfactant molecules which were used in the manufacture of rhenium nanoparticle 400.

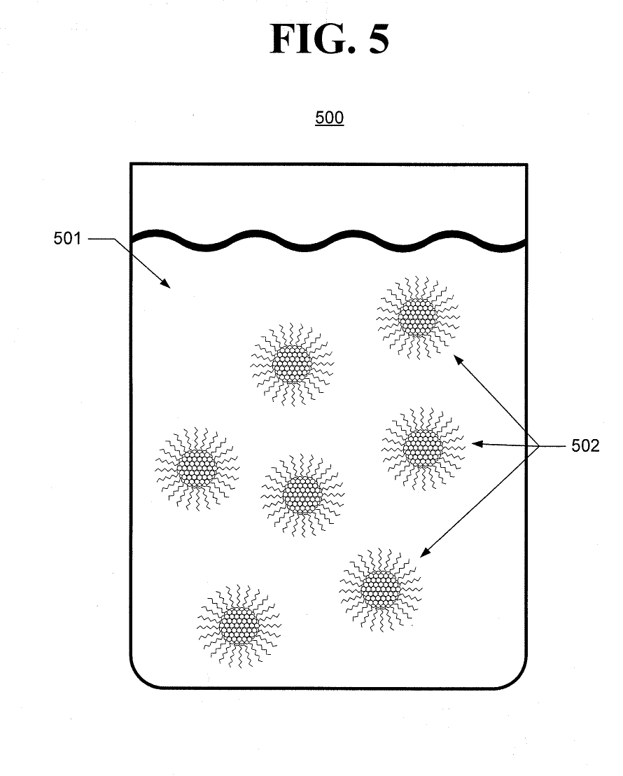

FIG. 5 illustrates a rhenium nanoparticle mixture in accordance with one aspect of the subject technology. Rhenium nanoparticle mixture 500 includes a solvent 501, in which are disposed a plurality of rhenium nanoparticles 502. The solvent 501 need not be the same solvent (e.g., the glyme solvent) used in the manufacturing process of rhenium nanoparticles 502. Rather, different solvents may be used in nanoparticle mixture 500 depending upon whether nanoparticle mixture 500 is to be used to distribute the nanoparticles on a substrate surface, as described in greater detail below, or whether nanoparticle mixture 500 is being stored. For example, in one aspect of the subject technology, solvent 501 is hexane CH₃(CH₂)₄CH₃, a solvent with a low boiling point (−69° C.), suitable for use in the rhenium nanoparticle coating processes described in greater detail below. Each rhenium nanoparticle 502 is surrounded by a layer of surfactant molecules which form a protective barrier around the nanoparticle, preventing it from chemically reacting with other substances, such as air or moisture. This protective layer of surfactants around each nanoparticle 502 allows mixture 500 to be handled with relative safety (e.g., as the pyrophoricity of the rhenium nanoparticles is negated thereby).

In accordance with various aspects of the subject technology, depending upon their size, rhenium nanoparticles 502 may either be dissolved in solvent 501, or may alternately form a slurry therewith. For example, in hexane, rhenium nanoparticles smaller than 10 nm will dissolve, while those larger than about 10 nm will not. Alternatively, in solvents such as xylene or toluene, larger nanoparticles will still be soluble. According to an additional aspect of the subject technology, when the size distribution of rhenium nanoparticles 502 is large enough (or if more than one narrow size range of rhenium nanoparticles is present), some nanoparticles may be dissolved in the solvent, while others form a slurry therewith.

The ability of some solvents to dissolve smaller rhenium nanoparticles than others can be exploited to separate nanoparticles of different sizes, in accordance with one aspect of the subject technology. For example, by introducing the rhenium nanoparticles into a hexane solvent, nanoparticles larger than 10 nm (i.e., those that do not dissolve in hexane) can be separated from nanoparticles smaller than 10 nm (i.e., those that do dissolve in hexane). These larger particles can then be introduced into a different solvent, such as xylene or toluene, to again separate smaller and larger particles (depending upon their solubility in this solvent). A third fraction of the nanoparticles can similarly be separated out by size in yet another solvent such as isopropyl alcohol (IPA). Nanoparticles (and agglomerates thereof) which are larger than about 100 nm will not dissolve well in any known organic solvent with low polarity.

In accordance with one aspect of the subject technology, rhenium nanoparticle mixture 500 may include rhenium nanoparticles 502 of a variety of sizes. For example, rhenium nanoparticles 502 may have a single, continuous particle size distribution, as a result of all the nanoparticles being created in a single reaction. Alternatively, rhenium nanoparticles 502 may have multiple non-continuous particle size distributions (e.g., as a result of mixing nanoparticles produced in separate reactions), where some of the nanoparticles are smaller (e.g. between 4 nm and 10 nm), and the remainder of the particles are larger (e.g., between 25 nm and 100 nm). It will be immediately apparent to one of skill in the art that the foregoing aspects are merely exemplary, and that the subject technology has application to rhenium nanoparticle mixtures with any size rhenium nanoparticles with any particle size distributions.

In one aspect of the disclosure, the discussions provided with respect to FIGS. 4 and 5 may apply to other nanoparticles such as Hf, Ta or W nanoparticles. In one aspect, the discussions provided with respect to FIGS. 4 and 5 may apply mutatis mutandis to other nanoparticles such as hafnium, tungsten or tantalum nanoparticles as if the term “rhenium” or “Re” were replaced with the term “hafnium,” “tungsten” or “tantalum”.

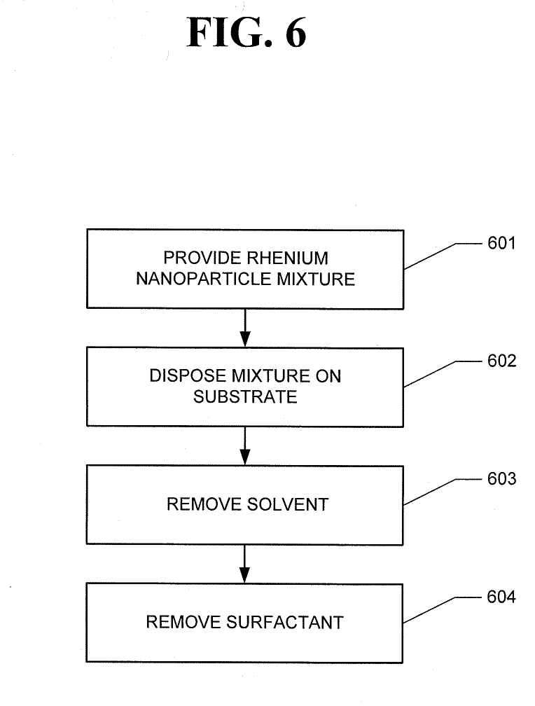

FIG. 6 is a flowchart illustrating a method for placing nanoparticles on a substrate in accordance with one aspect of the disclosure. The method begins with step 601, in which a nanoparticle mixture is provided. The nanoparticle mixture includes a solvent and a plurality of nanoparticles, each surrounded by a layer of surfactant molecules, as in, e.g., rhenium nanoparticle mixture 500 shown in FIG. 5. In one example, a nanoparticle mixture may be any metal nanoparticle mixture (e.g., a hafnium nanoparticle mixture, a tantalum nanoparticle mixture, or a tungsten nanoparticle mixtures) or any other type of nanoparticle mixture. One can vary the concentration of the mixture to achieve the desired level of density (e.g., the desired level of spacing or closeness between the nanoparticles).

In step 602, the nanoparticle mixture is disposed on a substrate. Many different methods may be employed to dispose the nanoparticles mixture onto a substrate: (i) a spin-coat approach; (ii) a spray-on approach; and (iii) a drop-coat approach.

According to one exemplary spin-coat approach, a substrate can be loaded. A substrate may be a silicon wafer (with or without a thin layer of insulator such as aluminum oxide or silicon oxide). A typical substrate size may be 4 inches or 6 inches or 10 inches in diameter, but the method is not limited to a particular substrate size. A substrate may be made of another type of material and other sizes. The substrate is then spun at a speed such as 1000 revolution per minute (rpm). The nanoparticle mixture from step 601 may be dropped onto the substrate that is spinning.

According to one exemplary spray-on approach, the nanoparticle mixture from step 601 may be spray painted onto a substrate (e.g., any of the substrates described above). For example, 2 ml of the nanoparticle mixture may be used for a 6 inch wafer. In one example, a robot may be used for automatic spray.

According to one exemplary drop-coat approach, the nanoparticle mixture may be simply dropped onto a substrate (e.g., any of the substrates described above). This approach may be useful when one desires to have nanoparticles only on a portion or portions of a substrate (e.g., only 1 cm diameter of the substrate) rather than the whole substrate. Depending on the viscosity and surface tension, the nanoparticle mixture will spread on the substrate.

In step 603, the solvent in the nanoparticle mixture is removed. The solvent may evaporate with or without heating and with or without a gas (e.g., argon) flow. After the solvent is removed, the nanoparticles may still be surrounded by surfactant molecules (see, e.g., 402 in FIG. 4), which can act as a protective layer.

In one example, the solvent may be removed from the nanoparticle mixture by heating the substrate to a first temperature, leaving the nanoparticles with the protective layer arranged in a lattice on the surface. In this example, the first temperature is chosen to be a temperature sufficiently high enough to evaporate the solvent, but not high enough to evaporate the surfactant molecules. For example, if the solvent is hexane, and the surfactant molecules are hexylamine molecules, then the temperature may be between 125° C. and 175° C.

Still referring to FIG. 6, the process may, optionally, continue with step 604, in which the substrate coated with the nanoparticles surrounded by surfactant molecules is heated to a second temperature to remove the surfactant molecules from the nanoparticles. In one example, if the surfactant is hexylamine, then the second temperature may be between about 200° C. and 300° C.

Depending upon the surfactant (or combination of surfactants) present in the nanoparticle mixture, the volume of the protected nanoparticles may be significantly larger than the unprotected nanoparticles left after the second heating step. For example, if the (single) surfactant used is hexylamine, the volume of rhenium nanoparticles contracts by about 17% after the second heating step.

In another aspect of the disclosure, step 604 may be skipped because if a chemical vapor deposition (CVD) reactor is utilized to form nanotubes, then the surfactant molecules may be removed in the reactor when the reactor is heated, for example, to about 200° C. to 300° C.

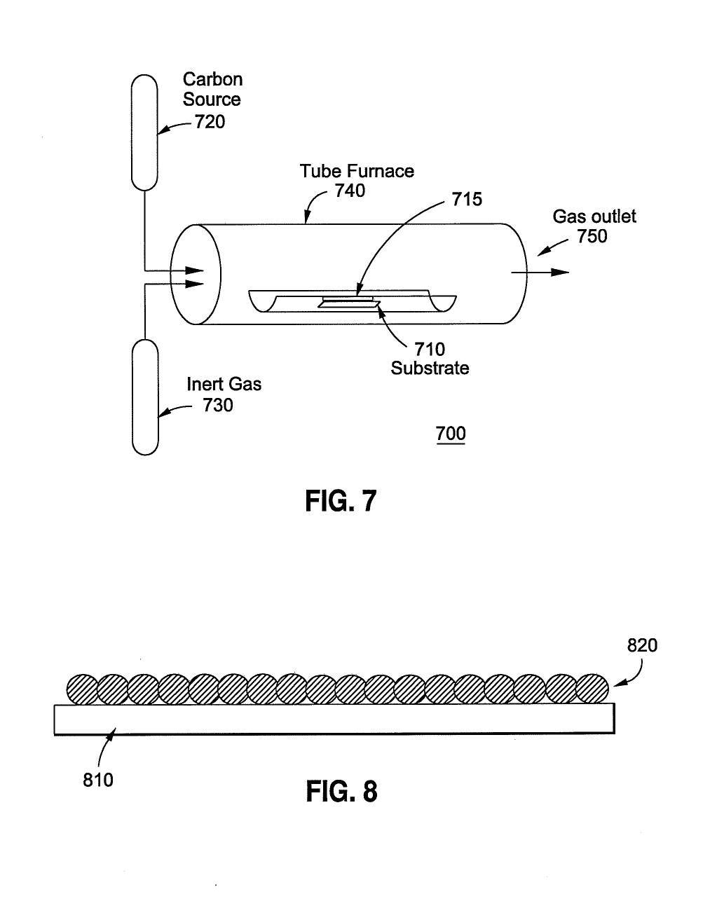

FIG. 7 is a schematic block diagram illustrating an example of a chemical vapor deposition (CVD) reactor that can be employed to grow nanotubes according to one aspect of the disclosure.

A substrate 710 with nanoparticles (with or without the protective surfactant molecules) 715 may be placed in a chemical vapor deposition (CVD) reactor such as reactor 700. In one example, substrate 710 with nanoparticles 715 may have been produced as illustrated in FIG. 6. In one aspect, nanoparticles 715 (after the protective surfactant molecules are removed) can act as catalysts for forming nanotubes.

In the illustrated example, the reactor 700 includes tube furnace 740, carbon source 720, inert gas source 730, and gas outlet 750. Carbon atoms from carbon source 720 and inert gas (e.g., Ar or He) molecules from inert gas source 730 are introduced inside furnace 740. In particular, the gaseous mixture of the carbon atoms and the inert gas molecules flows above the coated substrate 710. Some carbon atoms in the gaseous mixture are captured by the nanoparticles 715 on substrate 710 to initiate growth of carbon nanotubes. The inert gas and used carbon atoms exit tube furnace 740 via gas outlet 750.

While FIG. 7 shows one substrate placed horizontally within tube furnace 740, a plurality of substrates coated with nanoparticles can placed in a furnace so that nanotubes can be grown on the plurality of substrates simultaneously during one nanotube fabrication run. The plurality of substrates may be placed vertically in the furnace.

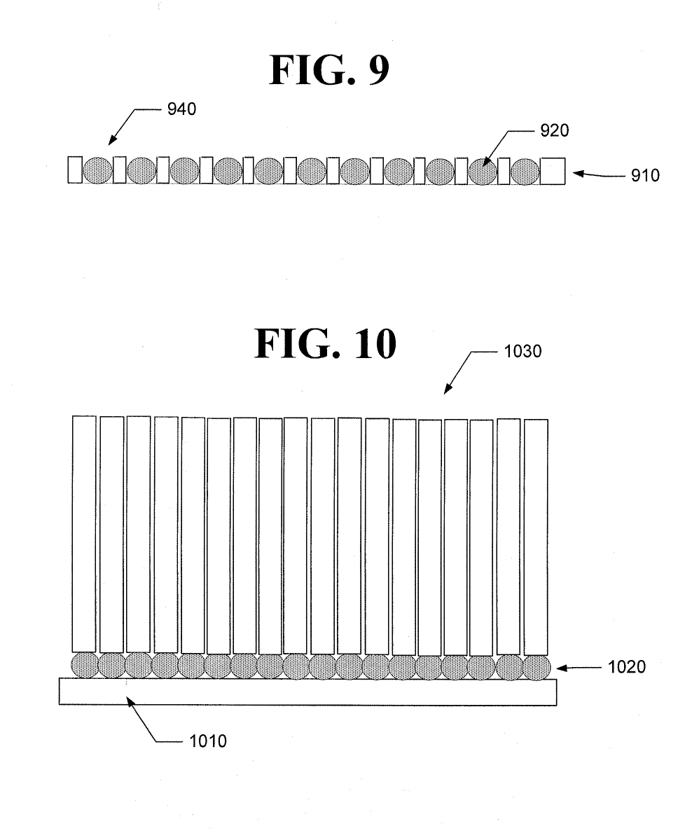

FIG. 8 is an example of a diagram illustrating a substrate 810 with nanoparticles (with or without protective surfactant molecules) 820 according to one aspect of the disclosure. FIG. 9 is another example of a diagram illustrating a substrate 910 with nanoparticles (with or without protective surfactant molecules) 920 according to one aspect of the disclosure.

In FIG. 9, substrate 910 has pores (or channels) 940 so that nanoparticles 920 can be held in place in these pores 940. Pores 940 may provide stabilizing well structures for nanoparticles 920 so that there is less tendency for migration of the nanoparticles. Pores 940 can prevent nanoparticles from getting combined with each other and from becoming larger. When the nanoparticles become larger, this can produce non-uniform nanotubes. Each pore may have a size similar to the size of a nanoparticle. In one example, an average pore size may be between 1 and 2 nm. Substrates with nanoparticles such as those shown in FIG. 8 or FIG. 9 or another type can be placed into a CVD reactor to grow nanotubes. FIG. 10 is an example of a diagram illustrating carbon nanotubes 1030 grown on nanoparticles 1020, which are on substrate 1010, according to one aspect of the disclosure.

In accordance with one aspect of the subject technology, nanoparticles (e.g., 820, 920, 1020) can be refractory metal nanoparticles such as Re, W, Ta, or Hf nanoparticles, and these nanoparticles can be used as catalyst particles for highly controlled growth of carbon nanotubes (e.g., 1030) such single-walled carbon nanotubes (SWCNTs). In one aspect, the very high melting point of such a metal (such as Re, W, Ta, Hf) combined with the low carbon solubility of such a metal at typical CVD process temperatures (below 1200° C.) results in a low carbon atom mobility within the metal nanoparticle. The nucleation and growth of a carbon nanotube occurs on the surface of a metal nanoparticle. The use of a high-melting, low solubility metal is considered advantageous because the flux of carbon atoms to the reaction site will be dominated by diffusion of carbon over the surface of the nanoparticle over any competing, multistep process of dissolution of carbon into the nanoparticle interior followed by diffusion to the surface. Furthermore, the very high melting point of such a metal (such as Re, W, Ta, Hf) means that the nanoparticle surface will be more stable in its configuration (atomic arrangement) at CVD temperatures than that of a lower melting metal particle. This higher degree of surface stability assists the assembly of a carbon atoms into an ordered structure of a carbon nanotube. Furthermore, the higher melting metals are less susceptible to processes such as particle size changes (Ostwald ripening) or metal migration into the substrate, which disrupt the size (diameter) distribution of the final carbon nanotube product.

In accordance with one aspect of the disclosure, a carbon nanotube product may include a plurality of carbon nanotubes and a plurality of nanoparticles. The plurality of nanoparticles may be on a substrate. In one aspect, each of the plurality of nanoparticles may comprise rhenium, tungsten, tantalum, or hafnium.

In one aspect of the disclosure, each nanoparticle (e.g., each of the nanoparticles produced from a batch of mixture as described with reference to FIG. 1 or each of the nanoparticles placed on a substrate as shown in FIG. 8) may have a diameter greater than 0 nm and less than 1000 nm (e.g., 1 nm, 2 nm, 3 nm, 5 nm, 50 nm, 60 nm, 70 nm, 100 nm, 150 nm, 200 nm, 230 nm, 400 nm, 900 nm, or any number less than 1000 nm). In one aspect, the rhenium nanoparticles may have a diameter greater than 0 nm and less than 10 nm. In one aspect, it may be advantageous to use rhenium nanoparticles having a diameter between 1 nm and 2 nm. These are merely examples, and the subject technology is not limited to these examples.

In one aspect of the disclosure, each nanotube (e.g., each of the nanotubes on a substrate as shown in FIG. 10) may have a diameter greater than 0 nm and less than 1000 nm (e.g., 1 nm, 2 nm, 3 nm, 5 nm, 50 nm, 60 nm, 70 nm, 100 nm, 150 nm, 200 nm, 230 nm, 400 nm, 900 nm, or any number less than 1000 nm). In one aspect, carbon nanotubes grown from rhenium nanoparticles (as catalysts) may have a diameter greater than 0 nm and less than 10 nm. In one aspect, carbon nanotubes grown from rhenium nanoparticles may preferably have a diameter between 1 nm and 2 nm. These are merely examples, and the subject technology is not limited to these examples.

In one aspect of the disclosure, the nanoparticles (e.g., the nanoparticles produced from a batch of mixture or the nanoparticles on a substrate) are monodispersed in that the nanoparticles are uniform in size. For example, nanoparticles having an average diameter between 1 nm and 3 nm may have a uniformity of +/−<1 nm of its average value, where the symbol “<” refers to “less than”. As another example, nanoparticles having an average diameter between 4 nm and 8 nm may have a uniformity of +/−1 nm. As another example, nanoparticles having an average diameter between 9 nm and 19 nm may have a uniformity of +/−2 nm. As another example, nanoparticles having an average diameter between 20 nm and 100 nm may have a uniformity of +/−3 to 5 nm. As yet another example, nanoparticles having an average diameter between 101 nm and 999 nm may have a uniformity of +/−5 to 25 nm. These are merely examples, and the subject technology is not limited to these examples.

In one aspect of the disclosure, the nanotubes (e.g., nanotubes grown on one substrate or nanotubes grown in one nanotube fabrication run) are uniform in size. For example, nanotubes may be grown to a particular diameter size depending on, for example, the diameters of the nanoparticles used as catalysts, the growth temperature(s), the gas flow rate(s), and the pressure of the reactor. As an example, if the average diameter of the nanotubes is between 1 nm and 3 nm, then the nanotubes may have a uniformity of +/−<1 nm of its average diameter. As another example, if the average diameter of the nanotubes is between 4 nm and 8 nm, then the diameters of the nanotubes may be within +/−1 nm of the average diameter. As another example, if the average diameter of the nanotubes is between 9 nm and 19 nm, then the diameters of the nanotubes may be within +/−2 nm of the average diameter. As another example, if the average diameter of the nanotubes is between 20 nm and 100 nm, then the diameters of the nanotubes may be within +/−3 to 5 nm of the average diameter. As yet another example, if the average diameter of the nanotubes is between 101 nm and 999 nm, then the diameters of the nanotubes may be within +/−5 to 25 nm of the average diameter. These are merely examples, and the subject technology is not limited to these examples. Furthermore, in another example, the uniformity of the nanotubes may be equal to or better than the uniformity of the nanoparticles used to fabricate the nanotubes. Stated in another way, the uniformity of the nanotubes may be equal to or better than the uniformity of the nanoparticles on which the nanotubes are grown.

In one aspect of the disclosure, when a nanotube is grown on a nanoparticle, the diameter of the nanotube is the same as the diameter of the nanoparticle in that if the nanoparticle has a diameter X, then a nanotube grown on the nanoparticle may have a diameter Y. For example, if the nanoparticles have an average diameter between 1 and 2 nm, then the nanoparticles have diameters of the average diameter+/−less than 1 nm. In this example, the nanotubes grown from these nanoparticles may have diameters greater than 0 nm but less than 3 nm. In another example, if the average diameter of the nanoparticles is 1.5 nm, then the nanoparticles are of diameters between 0.75 nm and 2.25 nm, and the corresponding nanotubes may have diameters greater than 0 nm but equal or less than 2.25 nm.

In one aspect of the disclosure, nanoparticles can be produced in a large quantity in a single batch. For example, a method described with reference to FIG. 1 can produce greater than 45 grams (g) of rhenium nanoparticles per liter (1) of a glyme solvent. An example may be to dissolve 67 g of NaReO₄ in 800 milliliters (ml) of a glyme solvent containing a surfactant mixture including 40 ml of diethylenetriamine, 20 ml of n-butyl amine, and 20 ml of SR₂ or RSH, and 20 ml of PR₃.

The nanoparticles produced from one batch of mixture may have the diameter and uniformity described above.

In one aspect of the disclosure, nanotubes can be produced in a large quantity in a single run (e.g., a single CVD fabrication run). For example, one 6-inch silicon wafer coated with 2-4×10¹⁴ number of 1 nm diameter rhenium nanoparticles may produce 0.075-0.15 grams of 1 nm diameter and 100 micron long nanotubes equaling 2-4×10¹⁴ carbon nanotubes (CNTs). In one aspect, the nanotubes produced from one substrate may have the diameter and uniformity described above. In another aspect, the nanotubes produced from one fabrication run may have the diameter and uniformity described above. One fabrication run may include one or more substrates coated with nanoparticles.

According to one aspect of the disclosure, the term “diameter” of a structure does not imply that the structure needs to be spherical. In one aspect, the term “diameter” may refer to a dimension of a cross section. In one aspect, the term “diameter” may refer to a dimension of the largest cross section of the structure.

Examples of procedures and mechanisms for growth of carbon nanotubes in general are provided in International Application Publication Number WO 2005/065100 and also in M. Ritschel et al., J. Phys. Chem. C 2007, 111, 8414-8417, both of which references are incorporated herein by reference in their entirety.

One exemplary method of growing carbon nanotubes is described below. A Re-supported MgO catalyst is prepared by wet mechanical mixing followed by a gas-producing combustion reaction with citric acid as a foaming and combustion additive. Ammoniumperrhenate (NH₄ReO₄) and magnesium nitrate ((Mg(NO₃)₂×6H₂O), which are mixed in different molar ratios (between 1 and 10), are dissolved in deionized water that contains a small amount of citric acid.

This mixture on a substrate is transferred directly into the preheated zone of a chemical vapor deposition (CVD) furnace (560° C.) where it is ignited and spontaneously burned. The reaction is accompanied by a large and strong release of different gases, which vary with the citric acid content. The total combustion process is finished after 10 minutes of exposure to result in a uniform, foamy material with a relatively high specific surface area (about 80 m²/g).

The synthesis of carbon nanotubes is carried out in a fixed-bed reactor consisting of a furnace with a quartz tube inside (diameter 40 mm). For the synthesis, a quartz boat containing the prepared catalyst material is placed in the hot zone of the horizontal reactor tube. At first, the reactor is exposed to a flow of Ar (about 250 standard cubic centimeters per minute (scc/min)) to remove the oxidizing atmosphere; afterward, the catalyst reduction is performed at 650° C. for 30 minutes in a hydrogen medium (about 150 scc/min). The temperature is increased by 6° C./min, up to the desired growth temperature between 950 and 1100° C., during the injection of CH₄ into the reactor. The CH₄ flow is stopped after the temperature has been maintained for 10 minutes. Finally, the furnace is cooled to 300° C. in a flow of hydrogen, and further cooling to room temperature is done under a flow of Ar.

For the purification, the as-grown products are sonicated in nitric acid (HNO₃) for 2 hours at room temperature. They are then filtered and washed with deionized water and dried at 110° C. for several hours.

Another exemplary method of growing carbon nanotubes is described below. Single-walled nanotubes (SWNT) by CO disproportionation can be produced by utilizing a catalyst with a Co:Re molar ratio of 1:4 under different conditions. For the SWNT production on the Co—Re/SiO₂ catalysts, 0.5 g of a calcined sample is placed in a horizontal tubular packed-bed reactor. The reactor is 12 inches long and has a diameter of 0.5 inches. After loading the catalyst, the reactor is heated in 100 scc/min H₂ flow to different temperatures in the range 600° C.-900° C. at 10° C./min.

Then, under 100 scc/min flow of He, it is heated up at the same rate to the specified reaction temperature, which ranges from 750° C. to 950° C. Subsequently, CO is introduced at a flow rate of 850 cm³/min at 84 psia for 2 hours. At the end of each run, the system is cooled down under He flow. The total amount of deposited carbon is determined by temperature-programmed oxidation. Other carbon-containing gases or fluids can be used in substitute of CO.

According to one aspect of the disclosure, a method for manufacturing rhenium nanoparticles comprises providing a glyme solvent, providing a surfactant (e.g., first and second surfactants), providing a rhenium precursor NaReO₄, the rhenium precursor including rhenium and one or more additional elements, providing a reactant (e.g., ascorbic acid or NaBH₄) for reacting with the rhenium precursor to free the rhenium from the one or more additional elements, and forming rhenium nanoparticles based on a mixture of the glyme solvent, the surfactant, the rhenium precursor, and the reactant. Each of the rhenium nanoparticles is surrounded with a layer of molecules of the surfactant.

In one aspect, a solvent, a surfactant, a metal precursor, and a reactant may include one or more solvents, one or more surfactants, one or more metal precursors, and one or more reactants, respectively.

In one aspect, the rhenium precursor is sodium perrhenate NaReO₄, the reactant is NaBH₄, the glyme solvent is characterized by the chemical formula CH₃—O—(CH₂CH₂—O)ₓ—CH₃, where x is a positive integer, the surfactant is an amine characterized by the chemical formula CH₃(CH₂)ₓNH₂, where x is a positive integer.

In one aspect, the surfactant is selected from the group consisting of n-hexylamine (CH₃(CH₂)₅NH₂), n-nonylamine (CH₃(CH₂)₈NH₂) and n-dodecylamine (CH₃(CH₂)₁₁NH₂).

In one aspect, the step of forming rhenium nanoparticles includes controlling a temperature of the glyme solvent to control an average size of the rhenium nanoparticles. The second surfactant is combined with the rhenium precursor, the reactant and the surfactant in the glyme solvent. An average diameter of the rhenium nanoparticles may be 1 to 2 nanometers. The rhenium nanoparticles may be formed in an amount greater than 50 grams per liter of the glyme solvent.

According to one aspect of the disclosure, a method for manufacturing rhenium nanoparticles comprises the steps of providing a solvent (e.g., a glyme solvent, THF, or ED), providing a surfactant, providing a rhenium precursor (e.g., NaReO₄), the rhenium precursor including rhenium and one or more additional elements, providing a reactant (e.g., Na/Li/K with the promoter naphthalene for reacting with the rhenium precursor to free the rhenium from the one or more additional elements, and combining the rhenium precursor, the reactant and the surfactant in the glyme solvent to form rhenium nanoparticles and to surround each rhenium nanoparticle with a layer of molecules of the surfactant.

According to one aspect of the disclosure, a method for manufacturing rhenium nanoparticles comprises the steps of providing a solvent (e.g., a glyme solvent or THF), providing a surfactant, providing an organometallic rhenium precursor (e.g., ReCl₅), the rhenium precursor including rhenium and one or more additional elements. The rhenium is freed from the one or more additional elements by thermal decomposition, and forming rhenium nanoparticles based on a mixture of the glyme solvent, the surfactant, the rhenium precursor, and the reactant. Each of the rhenium nanoparticles is surrounded with a layer of molecules of the surfactant.

According to one aspect of the disclosure, a method for manufacturing rhenium nanoparticles comprises providing a glyme solvent, providing a surfactant, and reacting, in the glyme solvent, a rhenium precursor and a reactant to free a plurality of rhenium atoms from the rhenium precursor. The method also comprises combining, in the glyme solvent, the plurality of rhenium atoms to form a rhenium nanoparticle, and surrounding, in the glyme solvent, the rhenium nanoparticle with a layer of surfactant molecules.

In one aspect, the rhenium precursor is sodium perrhenate, reactant is NaBH₄, the glyme solvent is characterized by the chemical formula CH₃—O—(CH₂CH₂—O)ₓ—CH₃, where x is a positive integer, and the surfactant is an amine characterized by the chemical formula CH₃(CH₂)ₓNH₂, where x is a positive integer. The method also controls the temperature of the glyme solvent to control the size of the rhenium nanoparticle. The surfactant includes a first surfactant and a second surfactant, and the surrounding step includes surrounding the rhenium nanoparticle with a layer including molecules of the second surfactant (e.g., at least one or both of phosphine and a sulfur containing compound). The rhenium nanoparticle may have a diameter of less than 15 nanometers.

In one aspect of the disclosure, a rhenium nanoparticle mixture comprises a solvent and a plurality of rhenium nanoparticles, each of the plurality of rhenium nanoparticles being surrounded by a layer of surfactant molecules. In one aspect, the term “a layer” may include one or more layers.

According to one aspect of the disclosure, a method for manufacturing nanoparticles is provided. The method comprises the steps of providing a glyme solvent, providing a surfactant, providing a precursor including one or more of Re, W, Ta, or Hf, and further including one or more additional elements other than Re, W, Ta, or Hf, providing a reactant for reacting with the precursor to remove the one or more additional elements, and forming nanoparticles based on a mixture of the solvent, the surfactant, the precursor, and the reactant. Each of the nanoparticles is surrounded with a layer of molecules of the surfactant.

According to one aspect of the disclosure, a rhenium nanoparticle mixture comprises a solvent and a plurality of rhenium nanoparticles, each of the plurality of rhenium nanoparticles being surrounded by a layer of surfactant molecules. The plurality of rhenium nanoparticles may have an average diameter of greater than 0 nanometer but less than 15 nanometers. The layer of surfactant molecules may include molecules selected from the group consisting of amines characterized by the chemical formula CH₃(CH₂)ₓNH₂, where x is a positive integer. The solvent may be a glyme solvent, which may be characterized by the chemical formula CH₃—O—(CH₂CH₂—O)ₓ—CH₃, where x is a positive integer. The solvent may be a hydrocarbon solvent.

According to one aspect of the disclosure, a method for forming a rhenium coating comprises providing a rhenium nanoparticle mixture, the rhenium nanoparticle mixture including a solvent and a plurality of rhenium nanoparticles, each of the plurality of rhenium nanoparticles being surrounded by a layer of surfactant molecules. The method also comprises disposing the rhenium nanoparticle mixture on a surface to be coated. The method may further comprise removing the solvent (e.g., heating the rhenium nanoparticle mixture to a first temperature to evaporate the solvent and leave the plurality of rhenium nanoparticles surrounded by surfactant molecules on the surface). The method may also comprise removing the surfactant (e.g., heating the rhenium nanoparticles and the surfactant molecules to a second temperature to remove the surfactant molecules and leave the plurality of rhenium nanoparticles on the surface).

In one aspect, the solvent is a hydrocarbon solvent. In another aspect, the solvent is hexane. In one aspect, surfactant molecules include one or more amines characterized by the chemical formula CH₃(CH₂)ₓNH₂, where x is a positive integer.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

In one aspect, the term “element(s)” may refer to a component(s). In another aspect, the term “element(s)” may refer to a substance(s). In yet another aspect, the term “element(s)” may refer to a compound(s).

Terms such as “top,” “bottom,” “front,” “rear” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an aspect may refer to one or more aspects and vice versa. A phrase such as an “aspect” does not imply that such aspect is essential to the subject technology or that such aspect applies to all configurations of the subject technology. A disclosure relating to an aspect may apply to all aspects, or one or more aspects. An aspect may provide one or more examples of the disclosure. A phrase such an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A method for manufacturing refractory metal nanoparticles, comprising:
providing a solvent;
providing a surfactant comprising a first surfactant configured to stabilize low oxidation states of a refractory metal and a second surfactant configured to protect refractory metal nanoparticles;
providing a refractory metal precursor, the refractory metal precursor comprising the refractory metal and one or more additional elements;
providing a reactant for reacting with the refractory metal precursor; and
forming the refractory metal nanoparticles surrounded by the second surfactant,
wherein the refractory metal comprises rhenium, tungsten, tantalum, or hafnium, and
wherein if the refractory metal comprises rhenium, the refractory metal nanoparticles comprise rhenium nanoparticles, if the refractory metal comprises hafnium, the refractory metal nanoparticles comprise hafnium nanoparticles, if the refractory metal comprises tantalum, the refractory metal nanoparticles comprise tantalum nanoparticles, and if the refractory metal comprises tungsten, the refractory metal nanoparticles comprise tungsten nanoparticles.

2. The method according to claim 1, wherein the first surfactant comprises an organic amine, and the second surfactant comprises at least one of phosphine and a sulfur containing compound.

3. The method according to claim 1, wherein the first surfactant comprises an organic amine, and the second surfactant comprises phosphine and a sulfur containing compound.

4. The method according to claim 1, wherein the first surfactant comprises an amine characterized by the chemical formula CH₃(CH₂)ₓNH₂ or (CH₃(CH₂)ₓ)₂NH, where x is a positive integer, pyridine, or diethylenetriamine, and
wherein the second surfactant comprises at least one of phosphine and a sulfur containing compound, wherein phosphine is PR₃ wherein P is phosphorus, and R is butyl, pentyl, hexyl, heptyl, octyl, nonyl, decyl, phenyl, or benzyl, and wherein the sulfur containing compound is one or both of RSH and RSR, wherein S is sulfur, H is hydrogen, R of RSH is C4 to C16, and R of RSR is C4 to C16.

5. The method according to claim 1, wherein the refractory metal comprises rhenium, and the refractory metal nanoparticles comprise rhenium nanoparticles, and
wherein the refractory metal precursor comprises sodium perrhenate (VII) (NaReO₄), and the solvent comprises a glyme solvent.

6. The method according to claim 5, wherein the refractory metal comprises rhenium, and the refractory metal nanoparticles comprise rhenium nanoparticles, and
wherein the reactant comprises ascorbic acid or sodium borohydride (NaBH₄).

7. The method according to claim 1, wherein the refractory metal comprises rhenium, and the refractory metal nanoparticles comprise rhenium nanoparticles,
wherein the refractory metal precursor comprises sodium perrhenate (VII) (NaReO₄), and
wherein the solvent comprises a glyme solvent, tetrahydrofuran (THF), or ethylenediamine.

8. The method according to claim 7, wherein the reactant comprises an alkaline-naphthalene mixture or LiAlH₄.

9. The method according to claim 1, wherein the reactant comprises alkaline-naphthalene with alkaline being either Na, Li or K.

10. The method according to claim 9, wherein the refractory metal comprises hafnium,
wherein the refractory metal precursor comprises HfCl₄, and
wherein the solvent comprises a glyme solvent, tetrahydrofuran (THF), or ethylenediamine.

11. The method according to claim 9, wherein the refractory metal comprises tantalum,
wherein the refractory metal precursor comprises TaCl₅, and
wherein the solvent comprises a glyme solvent, tetrahydrofuran (THF), or ethylenediamine.

12. The method according to claim 9, wherein the refractory metal comprises tungsten,
wherein the refractory metal precursor comprises WCl₆, and
wherein the solvent comprises a glyme solvent, tetrahydrofuran (THF), or ethylenediamine.

13. The method according to claim 1, wherein the providing a solvent, the providing a surfactant, the providing a refractory metal precursor and the providing a reactant are performed at a temperature below 0° C.

14. The method according to claim 1, wherein the providing a solvent, the providing a surfactant, the providing a refractory metal precursor and the providing a reactant create a mixture of the solvent, the surfactant, the refractory metal precursor and the reactant, and
wherein the method further comprises: raising a temperature of the mixture for thermal decomposition to free the refractory meal from one or more elements in the mixture.

15. The method according to claim 1, wherein the refractory metal precursor comprises an organometallic rhenium compound,
wherein the solvent comprises a glyme solvent or tetrahydrofuran (THF), and
wherein the reactant comprises LiR where R is an organic group with a beta hydrogen to allow beta elimination decomposition to occur.

16. The method according to claim 1, wherein the refractory metal precursor comprises an organometallic hafnium compound,
wherein the solvent comprises a glyme solvent or tetrahydrofuran (THF), and
wherein the reactant comprises LiR where R is an organic group with a beta hydrogen to allow beta elimination decomposition to occur.

17. The method according to claim 1, wherein the refractory metal precursor comprises an organometallic tantalum compound,
wherein the solvent comprises a glyme solvent or tetrahydrofuran (THF), and
wherein the reactant comprises LiR where R is an organic group with a beta hydrogen to allow beta elimination decomposition to occur.

18. The method according to claim 1, wherein the refractory metal precursor comprises an organometallic tungsten compound,
wherein the solvent comprises a glyme solvent or tetrahydrofuran (THF), and
wherein the reactant comprises LiR where R is an organic group with a beta hydrogen to allow beta elimination decomposition to occur.

19. The method according to claim 1, wherein each of the refractory metal nanoparticles is surrounded by molecules of the second surfactant, and an average diameter of the refractory metal nanoparticles is between 1 nanometer and 2 nanometers.

20. The method according to claim 1, wherein the forming the refractory metal nanoparticles comprises forming the refractory metal nanoparticles in an amount of at least 40 grams per liter of the solvent.

21. The method according to claim 1, further comprising:
heating a mixture of the solvent, the surfactant, the refractory metal precursor and the reactant to overcome repulsive forces;
removing the solvent; and
dissolving the refractory metal nanoparticles in a nonpolar solvent.

22. A method for manufacturing carbon nanotubes comprising the method according to claim 1 and further comprising:
disposing the refractory metal nanoparticles on a substrate;
providing carbon atoms; and
forming carbon nanotubes on the refractory metal nanoparticles.

23. The method according to claim 22, wherein the substrate is greater than 4 inches, the number of the refractory metal nanoparticles is sufficient enough to cover the substrate, an average diameter of the refractory metal nanoparticles is between 1 nanometer and 2 nanometers, and the refractory metal nanoparticles have a uniformity of +/−less than 1 nm of the average diameter,
wherein the carbon nanotubes have an average diameter of greater than 0 nm and equal to or less than 1.5 nm, and a uniformity equal to or better than the uniformity of the refractory metal nanoparticles.

24. A carbon nanotube product, comprising:
a plurality of refractory metal nanoparticles; and
a plurality of carbon nanotubes on the plurality of refractory metal nanoparticles,
wherein the plurality of refractory metal nanoparticles comprises a plurality of rhenium nanoparticles, a plurality of tungsten nanoparticles, a plurality of tantalum nanoparticles, or a plurality of hafnium nanoparticles,
wherein if the plurality of refractory metal nanoparticles comprises a plurality of rhenium nanoparticles, then the plurality of refractory metal nanoparticles has an average diameter greater than 0 nanometer and less than 999 nanometers, and the plurality of refractory metal nanoparticles are monodispersed.

25. The carbon nanotube product according to claim 24, wherein the plurality of refractory metal nanoparticles are monodispersed with a +/−less than 1 nm uniformity if an average diameter of the plurality of refractory metal nanoparticles is between 1 and 3 nm, with a +/−1 nm uniformity if an average diameter of the plurality of refractory metal nanoparticles is between 4 and 8 nm, with a +/−2 nm uniformity if an average diameter of the plurality of refractory metal nanoparticles is between 9 and 19 nm, with a +/−10% uniformity if an average diameter of the plurality of refractory metal nanoparticles is between 20 and 100 nm, and with a +/−5-25 nm uniformity if an average diameter of the plurality of refractory metal nanoparticles is between 101 and 999 nm.

26. The carbon nanotube product according to claim 24, wherein an average diameter of the plurality of refractory metal nanoparticles is between 1 nanometer and 2 nanometers, and the plurality of refractory metal nanoparticles has a uniformity of +/−less than 1 nm of the average diameter,
wherein the plurality of carbon nanotubes has an average diameter of greater than 0 nm and equal to or less than 1.5 nm, and a uniformity equal to or better than the uniformity of the plurality of refractory metal nanoparticles.

27. The carbon nanotube product according to claim 24, further comprising a substrate,
wherein the substrate is greater than 4 inches, the number of the plurality of refractory metal nanoparticles is sufficient enough to cover the substrate, an average diameter of the plurality of refractory metal nanoparticles is between 1 nanometer and 2 nanometers, and the plurality of refractory metal nanoparticles has a uniformity of +/−less than 1 nm of the average diameter,
wherein the plurality of carbon nanotubes has an average diameter of greater than 0 nm and equal to or less than 1.5 nm, and a uniformity equal to or better than the uniformity of the plurality of refractory metal nanoparticles.

28. The carbon nanotube product according to claim 24, wherein the plurality of refractory metal nanoparticles comprises a plurality of rhenium nanoparticles.

29. The carbon nanotube product according to claim 24, wherein the plurality of refractory metal nanoparticles comprises a plurality of tungsten nanoparticles.

30. The carbon nanotube product according to claim 24, wherein the plurality of refractory metal nanoparticles comprises a plurality of tantalum nanoparticles.

31. The carbon nanotube product according to claim 24, wherein the plurality of refractory metal nanoparticles comprises a plurality of hafnium nanoparticles.
